(19) United States
(12) Patent Application Publication
(10) Pub. No.: US 2007/0130005 A1
(43) Pub. Date: Jun. 7, 2007

(54) Method for consumer data brokerage

(76) Inventor: Michael Jaschke, Deerfield Beach, FL (US)

Correspondence Address: BRINKLE Y, MORGAN, SOLOMON, TATUM, STANLEY, LUNNY,;& CROSBY, LLP, 200 E. LAS OLAS BLVD, SUITE 1900, FORT LAUDERDALE, FL, 33301, US

(21) Appl. No.: 11/292,440

(22) Filed: Dec. 2, 2005

(51) Int. Cl. G06Q 30/00

(52) U.S. Cl. 705/14

(57) ABSTRACT

The present invention provides a method to broker consumer data for the purpose of marketing activities and to compensate consumers for the use of their data. The method provides mechanisms and processes for consumer information brokers to allow providers of real-time advertisement platforms or any static advertisement platform to offer advertisers the opportunity to dynamically bid on individual direct to consumer advertisement opportunities and to adapt individual advertisements according to the profile of each consumer. Furthermore the method allows consumer information brokers to offer marketers targeted direct to consumer marketing measures based on well-defined target profiles. Consumers have the opportunity to allow advertisers to convey advertisements to them and be compensated for viewing them. They may also opt out and forego the opportunity. Furthermore consumers have the opportunity to participate in direct to consumer marketing measures and be compensated for participating. This will lead to significantly improved return on investment for businesses and help them to develop products and services that consumers really want.

### BACKGROUND OF THE INVENTION

Advertising and marketing today are dominated by hypotheses, projections, models, third party data, statistics and algorithms. They are often based on histories or analogies derived from similar markets. There is often a lack of relevant real consumer data throughout the entire marketing process. The reason for this is that this data is often very difficult to come by; it is very expensive and it is time consuming to derive such data. Sometimes it might even be impossible using today's methods. The involvement of most consumers in the marketing process is limited to the backend of the marketing process—the product launch and the rollout phase. This happens primarily through advertising.

This lack of consumer involvement in the creation of new products and services leads to high product cost, wrong or poor product design and very high direct to consumer marketing expense. The profitability and success of many companies often rides on a few blockbuster products, which is a clear indicator that the predictability of market success is not a science but an educated guess. The loss of investment due to products that under perform or fail is huge. By including consumers at the beginning of the marketing process, companies can reduce the risk associated with the development of new products and services and therefore increase their overall profitability.

When it comes to advertisement, we often find that there is no real targeted approach. This is due to the media that advertisers use in order to get the best possible audience and to the difficulty of directly approaching consumers with a certain profile. Consumers are bombarded with advertisements; be it on television, radio, the Internet, billboards, print material, direct mail, etc. In 2004, businesses in the United States (U.S.) spent $264 billion in advertising. 31 marketers in the U.S. each spent more than $1 billion, with the car industry leading the pack.

While advertisements have an important role to play in conveying information about new products and services, consumers often consider advertisements annoying. The reason for this is that consumers often perceive advertisements to take control of their time with information that doesn't fit their lifestyle or interest. Most of the time the interest in advertisements is coincidental, which leads in general to very low response rates.

Response rates vary between 0.15% and 1% depending on the type of list with which the advertisers are working (house or prospect), the industry in which the advertisers work, their offer, and the objective (purchases, donations, lead generation, traffic generation) of their campaign. This means that the effectiveness and return on investment is extremely poor and there is a huge potential for improvement.

The advent of the knowledge and data based society allows for the massive collection of consumer data. This data is derived by any activity consumers perform today, be it their buying habits reflected in data on their credit card records, their interests reflected in Internet surfing behavior, any public information reflected in public records etc. In the 1990s, corporations in the U.S. built huge data warehouses hosting a tremendous amount of transactional data. Most of the companies were not able to derive much value for new products out of it.

One of the reasons is that what consumers do and how they do it does not necessarily reflect what they would like to do. There is certainly value in observing data in order to make existing products better, but the approach lacks the ability to lead to innovative new products and services, which are the growth engine of any successful company.

The simplest way to create a successful product is to make what consumers really want. In order to achieve this, corporations need an active and direct dialogue with consumers who fit their target group.

While many consumers have big fears about the use of information collected about them, there are key advantages for consumers and businesses to collect this data. Consumer data does not have to be personalized but can be de-identified which allows consumers to remain anonymous while at the same time being well understood as a prospective buyer.

Direct consumer data would support marketers in the entire life cycle process of the product. A new dialogue will create products that meet consumers' interests and lead to a much better return on investment for businesses.

### SUMMARY OF THE INVENTION

The present invention provides a method to broker consumer (“target”) information for the purpose of marketing activities and to compensate consumers (“targets”) for the use of their information. This will lead to significantly improved return on investment for businesses and help them to develop products and services that consumers really want.

Throughout the claims and specification, a target can be an individual, a consumer, a business, or any other entity that utilizes real time advertising platforms and/or receives marketing materials. A target is not limited to an individual who purchases goods for personal use, but may include any person and/or entity that receives information via real time advertising platforms and/or conventional advertising platforms.

The invention provides (1) a method for providing marketing materials to targets in real time (e.g. via the Internet, television, telephone, etc.), whereby the target triggers the brokerage process by visiting real time advertisement platforms and (2) a method for providing direct-to-consumer marketing materials (e.g. direct mail, email, surveys, telemarketing, etc.), whereby the marketer triggers the brokerage process by requesting the relay of direct-to-consumer marketing materials to targets through the consumer information broker.

Throughout the claims and specification, marketing materials include real-time advertisements and direct-to-consumer marketing materials. Real-time advertisements include but are not limited to promotional materials, advertisements, catalogs, circulars, commercials, political commentary, sales announcements, want ads, surveys, questionnaires and any other materials that are suitable for distribution in real-time. Direct-to-consumer marketing materials include, but are not limited to promotional materials, static advertisements, surveys, questionnaires, telemarketing calls, direct mails, direct sales initiatives, catalogs, circulars, political commentary, sales announcements, want ads and any other material suitable for distribution in delayed-time.

Throughout the claims and specification, real time advertisement platforms include, but are not limited to, the Internet, cable and satellite networks, mobile and fixed telephone networks, digital billboards, advertisements on receipts at the point of sale and any other real-time advertisement space.

The invention provides (1) a method for consumer information brokers to allow providers of real-time advertisement platforms to offer advertisers the opportunity to dynamically bid on individual real-time advertisement opportunities and to adapt the marketing materials based on the specific profile of each target.

The invention provides (2) a method for consumer information brokers to allow marketers to contact targets with direct-to-consumer marketing materials based on well-defined target profiles.

Targets have the opportunity to allow advertisers to convey marketing materials to them and be compensated for viewing them. They may also opt out and forego the opportunity. Furthermore targets have the opportunity to participate in direct-to-consumer marketing measures and be compensated for participating.

Consumer information brokers manage (1) the process of identifying advertisement platforms and opportunities and presenting those to advertisers, correlating target profile data with descriptions provided by the advertiser, de-identifying the target data, determining the winning advertiser, conveying an advertisement from the winning advertiser to the target, charging the advertiser's account, and crediting the accounts of the target, the advertisement platform provider and/or the profiler.

Consumer information brokers also manage (2) the process of identifying suitable targets for direct-to-consumer marketing campaigns based on descriptions provided by marketers. The consumer information broker de-identifies the target data and provides electronic relay (forwarding) services and/or address labeling services in order to convey marketing materials of contracting marketers to identified targets. They charge the marketers' accounts and credit the accounts of the targets, the profiler and/or the advertisement platform provider.

Throughout the claims and specification, advertisers and marketers include, but are not limited to marketing firms, companies, retailers, wholesalers, political groups, interest groups, governmental bodies, employee search firms, individuals, and any other individual or entity that wishes to communicate with one or more targets.

A consumer information broker can also be an advertisement platform provider, advertiser, marketer, profiler, target or any combination thereof.

The following description will explain the invention with an initial focus on the real-time advertisement aspect of the described method and finally explore direct-to-consumer marketing measures outside the advertisement domain.

Advertisement Brokerage

The invention can be realized for any real-time advertisement platform. Real-time advertisement platforms include, but are not limited to, the Internet, cable and satellite networks, mobile and fixed telephone networks, digital billboards, advertisements on receipts at the point of sale and any other real-time advertisement space. Real-time advertisements, can include, but are not limited to promotional materials, advertisements, catalogs, circulars, commercials, political commentary, sales announcements, want ads, surveys, questionnaires and any other materials that are suitable for distribution in real-time.

In a preferred embodiment the invention is realized over a communications network. However, as explained in further detail below, the invention can also be realized using delayed-time networks, such as via the postal service or placement of advertisements and/or other materials in magazines and/or newspapers.

The method allows a consumer information broker to alert advertisers that a potential opportunity for advertising has been identified. Advertisers can include marketing firms, companies, retailers, wholesalers, political groups, employee search firms, and any other entity that wishes to communicate with a target. Advertisers submit a bid for the advertisement opportunity along with a profile, referred to as the associated description throughout the specification and claims, which provides a virtual representation of the ideal target suitable for a particular advertisement. Furthermore advertisers make accessible a reference or link to marketing materials, which includes multiple advertisements and/or fragments thereof that can be combined to form one advertisement. The resulting advertisement is tailored to each target based on the target profile. The reference to marketing materials contains advertisement characterizations for all of the advertiser's advertisements and/or advertisement fragments associated with advertiser's associated description. The advertisement characterizations identify parameters that a target needs to match in order for the consumer information brokerage processor to select a particular advertisement or module.

All associated descriptions and references to marketing materials are stored in one or more bid databases that are accessed by the consumer information broker whenever an actual advertisement opportunity arises. Each entry in the database(s) also includes a bid price, a bid increment, and a unique identifier of when the data was stored into the database (“storage time”). Advertisers submit the associated description, bid price, bid increment and reference to marketing materials prior to the actual advertisement opportunity. The storage time is affixed to the information upon receipt of the submission. Using this practice, the bid and bid increment are fixed prior to notice of any advertisement opportunity. Once an advertiser has entered its bid, they are automatically eligible to participate in the bidding for any advertisement opportunity.

When targets visit an advertisement platform, a trigger or indication of availability is automatically sent through the communications network to the consumer information broker indicating that an advertisement opportunity is available. Advertisement platforms include, but are not limited to, mobile telephones or pagers connected to a Mobile Switching Network; telephones connected to the Public Switched Telephone Network (“PSTN”); Personal Computers (PCs) connected to the Internet via the PSTN, a satellite network or a cable network; set top boxes connected to cable networks or satellite networks; television (TV) sets connected to cable networks, satellite networks or the PSTN; laptops or Personal Digital Assistants (PDAs) connected to a Wireless Fidelity (“WiFi”) network; or digital billboards connected to a billboard server, print material in the form of direct mail or ads on receipts at the point of sale.

Once a target accesses any of those platforms, an advertisement trigger or indication of availability is sent over the communications network to a consumer information broker. This can be implemented using cookies on the PC of the target, memory based identifiers (e.g. Subscriber Identity Module (SIM) cards, smart cards, computer memory, etc.), calling number identifiers, fixed IP addresses, cable or satellite TV identifiers or any other means of uniquely identifying a user.

After receiving notification of an advertising opportunity, the consumer information broker requests the target profile from one or more target profile processor(s) and correlates the target profile to the associated description of each advertiser participating in the bidding process. In a preferred embodiment, the target profile is a data representation of the target. The information is collected through (1) the active data input of the target into databases of target profile processors, (2) the tracking of the usage behavior of targets which is collected in the databases of target profile processors, (3) the tracking of usage behavior of the target which is stored in digital memory (e.g. smart cards, (SIM) cards, computer memory, etc.) or cookies residing on the targets' premise equipment, and (4) the active data input of third parties concerning that particular target into databases of target profile processors.

The consumer information broker determines which advertiser will be permitted to utilize the advertisement opportunity by using a mathematical calculation. In a preferred embodiment, the bidding price is dynamically calculated based on a correlation between the associated description defined by the advertiser and the target profile, the correlation is then multiplied by the submitted bid price. This allows the bid for each advertisement opportunity to be dependent on how well a particular target profile correlates with the advertiser's associated description. The advertiser with the highest bid becomes the winning advertiser, the advertiser permitted to exploit the advertisement opportunity.

In a preferred embodiment the consumer information broker selects an appropriate advertisement from the winning advertiser's reference to marketing materials. After the advertisement has been selected, it is conveyed to the target.

The entire process described is fully automated and does not require an auction type interaction between the advertiser and the consumer information broker.

Targets may select to view the advertisement (opt in) or to pass (opt out). In case targets decide to view the advertisement, they may be presented with a feedback mechanism.

Once confirmation is received that the target has received the advertisement and/or feedback is received from the target, the target may be compensated. The account of the winning advertiser (the advertiser with the highest bid) is charged in the amount of the winning bid.

Please note, the winning bid may not be identical to the original bid price submitted by the advertiser due to the correlation of the associated description to the target profile. In other words, the less of a match between the two profiles, the less the advertiser pays for the advertising opportunity. In addition, targets, advertisement platform providers and/or consumer information brokers may establish a minimum bid. Therefore, if the winning bid is below the minimum bid, the winning advertiser is charged the minimum bid rather than the winning bid.

The consumer information broker utilizes the winning bid to credit the account(s) of the target, the advertisement platform provider and/or the profiler. The consumer information broker may keep a percentage of the bid as a brokerage fee or charge a fixed amount to the advertisement platform provider, the target and/or the advertiser.

Targets will receive advertisements that match their interest and lifestyle and take into consideration their cultural, social and economic backgrounds. This will lead to more effective advertising and better return on investment for advertisers. Advertisers will be able to increase their response rates. Advertisers compensate targets for viewing their advertisements in the form of cash, vouchers, bonus programs, discounts or other legal incentives.

Direct To Consumer Marketing Brokerage

In an alternate embodiment, but utilizing the same infrastructure, consumer information brokers receive an associated description from marketers together with a reference to marketing materials. The consumer information broker identifies suitable targets based on the associated description and conveys the marketing materials to suitable targets.

Marketers are able to maintain direct relationships with the targets throughout the entire lifecycle of the product. This will reduce the amount of products that do not live up to business plan projections, lower the cost of product introduction and ultimately lead to a better return on investment for businesses. Targets will be involved in the marketing process, receive compensation for their efforts and get products that they really want.

### BRIEF DESCRIPTION OF THE DRAWINGS

FIG. 1 is a representation of the relationship of all transaction partners, the networks, processors and customer premise equipment, which are involved in the processes described in the invention.

FIG. 2 is an example for a possible target profile.

FIG. 3 is a representation of a fictitious target profile named John.

FIG. 4 is an example of two possible associated descriptions.

FIG. 5a is an example of an advertisement correlation to a specific advertisement opportunity with a target.

FIG. 5 b is an example of an advertisement module correlation to a specific advertisement opportunity with a target.

### DETAILED DESCRIPTION OF THE INVENTION

In describing the invention and the associated drawings, specific terminology will be used for the sake of clarity. However, the invention is not intended to be limited to the specific terms so selected, and it is to be understood that each specific term includes all technical equivalents which operate in a similar manner to accomplish a similar purpose.

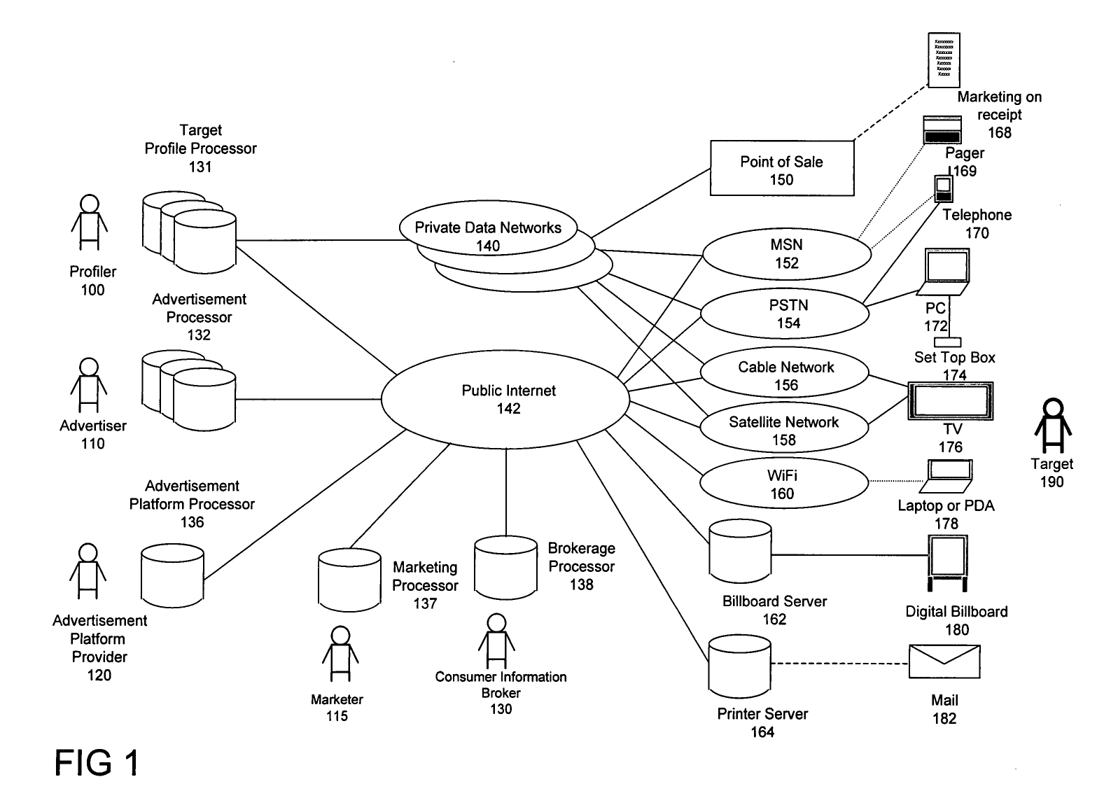

With reference to the drawings, in general, and FIGS. 1 through 5B in particular, the method and system of the present invention is disclosed.

FIG. 1 is a representation of the relationship of all transaction partners, the network(s), processor(s) and customer premise equipment, which are involved in the consumer data brokerage service.

The following is a short description of all transaction partners. Each transaction partner can be a combination of or a subset of all transaction partners.

A target 190 can be an individual, a business, or any other legal entity that utilizes real time advertising platforms and/or receives marketing materials.

A profiler 100 can be a profiler collecting target profiles by tracking usage behavior (e.g. Internet viewing, TV viewing, calling patterns, etc.), by tracking buying behavior (e.g. credit card records, point of sale records, loyalty records, etc.), by collecting target input based data (e.g. surveys, questionnaires, etc.), by collecting third party records (e.g. credit reports, criminal records, mortgage records, etc.) or by using any other legal means of collecting and storing target data in a target profile database located on one or more target profile processor(s) 131. The profiler may use one or multiple target profile processors 131 in order to provide electronic communication links to the consumer information broker 130. The target profile processor 131 contains one or more target profile databases that contain profiles of targets 190.

An advertiser 110 can be a company, an interest group, the government, an individual or any other person or legal body with the intent to render marketing materials to targets 190. The advertiser 110 may use one or multiple advertisement processors 132 in order to provide electronic communication links to the consumer information broker 130. The advertisement processor 132 may contain one or more advertisement databases that contain advertisements and/or advertisement modules. Each advertisement in the advertisement database has a unique identifier that is referenced in or linked to the corresponding advertisement characterization in the bid database. This allows advertisements delivered to the target 190 to be tailored to the target profile.

A marketer 115 can be a company, an interest group, the government, an individual or any other person or legal body with the intent to perform direct-to-consumer marketing to targets. The marketer 115 may use one or multiple marketing processors 137 in order to provide electronic communication links to the consumer information broker 130. The marketing processor 115 may contain one or more marketing databases that contain marketing material for targets 190.

An advertisement platform provider 120 can be a content provider, Internet Service Provider (ISP), Application Service Provider (ASP), cable TV provider, satellite TV provider, telephone network service provider, Wireless Fidelity (WiFi) network provider, digital billboard provider, direct mailing service or any other provider who offers communication services for targets. The advertisement platform provider 120 may use one or multiple advertisement platform processors 136 in order to provide electronic communication links to the consumer information broker 130.

A consumer information broker 130 brokers advertisement and marketing opportunities for the purpose of performing advertising or other marketing activities and may compensate targets 190 for the use of their information. The consumer information broker 130 may use one or multiple brokerage processors 138 in order to provide electronic communication links to one or more targets 190, one or more profilers 100, one or more advertisers 110, one or more marketers 115, and one or more advertisement platform providers 120. The brokerage processor 138 may contain one or more bid databases that contain bids for advertisement opportunities. Instead of the target profile database(s) being located on the target profile processor 132, the advertisement database(s) being located on the advertisement processor 132 and the marketing databases (s) being located on the marketing processor 137, all databases or a subset of all databases may be located on one or multiple brokerage processors 138.

Throughout the description and claims, the term “marketing materials” will be used in order to describe all advertisement and direct-to-consumer marketing materials. Real-time advertisements include, but are not limited to promotional materials, advertisements, catalogs, circulars, commercials, political commentary, sales announcements, want ads, surveys, questionnaires and any other materials that are suitable for distribution in real-time. Direct-to-consumer marketing materials include, but are not limited to promotional materials, static advertisements, surveys, questionnaires, telemarketing calls, direct mails, direct sales initiatives, catalogs, circulars, political commentary, sales announcements, want ads and any other material suitable for distribution in delayed-time.

The following detailed description will focus on real-time advertisement aspects of the described method and system, and then explore marketing measures outside the advertisement domain.

Advertisement Brokerage

In FIG. 1, a consumer information broker 130 brokers the advertisement process between target 190, profiler 100, advertisement platform provider 120 and advertiser 110. The consumer information broker 130 manages the process of identifying advertisement platforms and opportunities and presenting those to advertisers 110, correlating target profile data with the advertisers' associated descriptions, and determining the winning bid. The consumer information broker 130 may de-identify target data, convey the selected marketing materials to the target 190, charge the advertiser's account and credit the accounts of the target 190, the advertisement platform provider 120 and/or the profiler 100.

Once a consumer information broker 130 identifies a potential advertisement platform and/or advertisement opportunity, they send or make accessible a report of the opportunity to advertisers 110. This may include statistics of the targets 190 that visit the advertising platform and a minimum bid price. A potential advertisement opportunity is characterized by the nature of the advertisement platform, potential contents of the marketing material, and statistics about targets 190 visiting the advertisement platform.

Advertisers 110 have the opportunity to register to bid for advertisement opportunities with individual targets 190 on the advertising platform. For that purpose, the advertisers 110 send an associated description, a bid, a bid increment, and a reference to the advertisement characterizations to the consumer information broker 130. The associated description is a reflection/virtual representation of the ideal target 190 suitable for that particular advertisement. The associated description, the bid, the bid increment, and the reference to the marketing material for each advertiser 110 may be stored in one or more bid database(s) on the brokerage processor 138.

Advertisers 110 submit their data prior to the advertisement opportunity and in general only once. This process allows advertisers 110 to participate in the bidding process for all advertisement opportunities. The consumer information broker 130 utilizes the stored advertiser data (e.g. bid, bid increment, associated description, and reference to the marketing material) whenever an advertisement opportunity arises.

Targets 190 can use, but are not limited to, the following communications networks or real time advertising platforms in order to interact with advertisers 110: mobile telephones 170 or pagers 169 connected to a Mobile Switching Network 152; telephones 170 connected to the Public Switched Telephone Network (“PSTN”) 154; Personal Computers (PCs) 172 connected to the Internet 142 via the PSTN 154, a satellite network 158 or a cable network 156; set top boxes connected to cable networks 156 or satellite networks 158; television (TV) sets 176 connected to cable networks 156, satellite networks 158 or the PSTN 154; laptops or Personal Digital Assistants (PDA) 178 connected to a WiFi network 160; or digital billboards 180 connected to a billboard server 162. Additionally, targets 190 can be reached by advertisers 110 through print material from a printer server 164 in the form of direct mail 182 or ads on receipts 168 at the point of sale 150.

Once a target 190 accesses any of those communication networks, an advertisement trigger or indication of availability is sent over the communication network 142 to the brokerage processor 138 of a consumer information broker 130. This can be implemented using cookies on the PC 172 of the target 190, memory based identifiers (e.g. SIM cards, smart cards, computer memory, etc.), calling number identifiers, fixed IP addresses, cable or satellite TV identifiers or any other means of uniquely identifying a user. The brokerage processor 138 requests the target profile of that particular target 190 by accessing one or more target profile databases located on one or more target profile processors 131.

The target profile may include one or more factors, which includes an indication of which advertisers 110 are or are not permitted to convey marketing materials to the target 190. The advertisers 110 that are permitted to convey marketing materials to the target 190 are referred to as cleared advertisers. The brokerage processor 138 substantially correlates the target profile to the advertiser's associated description for all cleared advertisers.

As will be evident upon further explanation, the brokerage processor 138 correlates or compares the target profiles, associated descriptions and, as will be further discussed later in the process, the advertisement characterizations for marketing materials, for similar factors or parameters. In a preferred embodiment, the factors or parameters of target profiles, associated descriptions and the advertisement characterizations for marketing materials are the same. This means that all factors or parameters contained in the target profile are also contained in the associated description and in the advertisement characterization. However, an exact match between the three is not required to practice the present invention.

The correlation process compares each factor or parameter (hereinafter “parameter”) in the target profile to the corresponding parameter in the associated description or, in case of the advertisement selection method, to the advertisement characterizations of the marketing materials. Correlation may be determined based on the following mathematical or Boolean operators or any combination thereof: equal, unequal, smaller, smaller or equal, bigger, bigger or equal, True, False, And, Or or Exclusive Or. The available parameters and correlation operators for each advertisement opportunity are provided to the advertiser prior to its submission. For example, if the target profile and the associated description each contain an age parameter, the age parameter for the target profile is “25” and the age parameter for the associated description contains a range of numbers “20 to 28”, the correlation rule is “correlation is True if age parameter of target profile smaller or equal than 28 And bigger or equal 20.” The correlation result would return True, which would mean that the two data entries correlate. If the entry in the age parameter of the target profile is outside the range stored in the entry in the age parameter of the associated description, the correlation result would be False, which would mean that the two fields do not correlate. If the entry in the age parameter of the associated description is empty because no data entry was made, the correlation result would also be False, which means that the two fields would not correlate.

The parameters in the associated description may be the same or different from the parameters in the advertisement characterization. In addition, the parameters in the advertisement characterization may further itemize the parameters in the associated description. For example, an advertiser may submit an associated description with an age parameter of “15 to 30” and the advertisement characterizations may have age parameters “15 to 20,” “21 to 28,” and “29 to 30.” In other words, the advertiser has requested targets ranging in age from “15 to 30”, but has provided marketing materials that differ based on the final target's specific age group.

If more than one advertiser 110 has an associated description that correlates with the target profile for the target, the brokerage processor 138 multiplies the result of the correlation by the bid price of each advertiser 110 in order to determine the dynamic bid price for each advertiser 110. The dynamic bid price that is the highest (“highest bid price”) becomes the winning bid. One of the benefits for this type of system is that the dynamic bid price for each advertiser 110 is based on how close of a match the target profile for the target 190 has with the associated description. In other words, the advertiser 110 bids a higher amount for an opportunity that more closely matches its theoretical ideal target 190.

If more than one advertiser 110 has the same highest bid price, the brokerage processor 138 adds each advertiser's bid increment to the highest bid price. In this scenario, the advertiser 110 with the highest bid price and highest bid increment becomes the winning advertiser 110.

If two or more advertisers 110 each have the same highest bid price and the same bid increment, the brokerage processor 138 determines which advertiser 110 registered with the brokerage processor 138 first. Included in the associated description of the advertiser 110 is the storage time for each submission. When two or more advertisers 110 each have the same highest bid price and bid increment, the brokerage processor 138 determines which of the advertisers 110 stored its entry first (“earliest entry”).

Each of the groupings of advertisers 110 described (highest bid price, highest bid increment and earliest entry) provide a subset of the previous grouping, thereby narrowing the number of advertisers 110 available to participate in the advertising opportunity until there is only one advertiser 110.

Once the brokerage processor 138 determines the winning advertiser 110, the brokerage processor 138 correlates the advertisement characterization of the marketing materials of the winning advertiser 110 with the target's target profile in order to determine the appropriate advertisement for that particular target 190. As described previously, the reference to marketing materials includes one or more advertisement characterizations, each advertisement characterization including factors or parameters that targets 190 need to have in order to receive a specific advertisement. This allows the display of different advertisements to targets 190 based on the target's socio-economic and/or cultural backgrounds.

After the proper advertisement characterization has been identified, the brokerage processor 138 triggers the advertisement processor 132 to forward the corresponding advertisement to the target 190. The advertisement may be customized to the technical capabilities of the customer premise equipment and may be interactive. In other words, an advertisement conveyed to a cell phone may differ from an advertisement conveyed to a computer or television.

This process is repeated for each advertisement opportunity. Therefore, providing only one initial submission, advertisers 110 can vary advertisements depending on the specific target profile of the target 190.

The target profile is a data representation of a target 190. The information is collected through (1) the active data input of the target 190 into databases of target profile processors 131, (2) the tracking of the usage behavior of the target 190 which is collected in databases of target profile processors 131, (3) the tracking of usage behavior of the target 190 which is stored in digital memory (e.g. smart cards, SIM cards, computer memory, etc.) or cookies residing on the target's premise equipment, and (4) the active data input of third parties concerning that particular target 190 into databases of target profile processors 131. Relevant data can be collected from, but is not limited to the collection from points of sale 150 or online sales using payment system records; from online appointment scheduling using consumer information databases; from cookies tracking Internet viewing behavior; from Internet search engines tracking subjects of interest; from cable or satellite TV provider records tracking TV viewing behavior; from mobile or fixed telephone providers tracking service usage; from consumer surveys or from any public records. The quality of the record depends largely on the amount and accuracy of the information available. Targets 190 may offer information to profilers 100 at a price, which could be reflected in discounts, bonus and reward programs, cash or any other legal incentive.

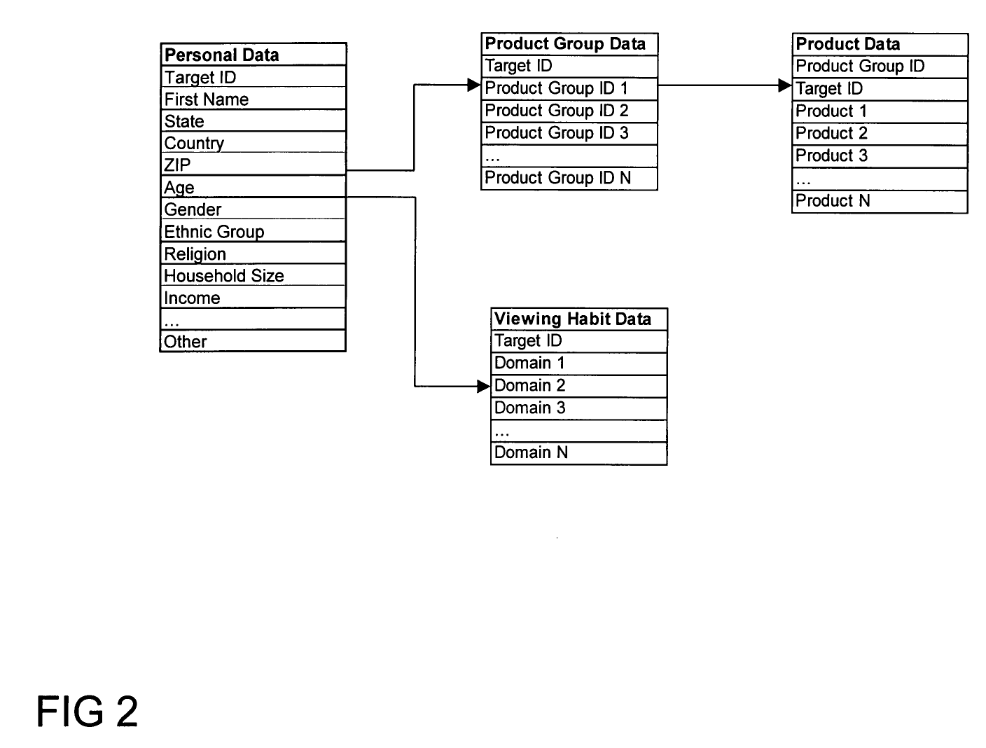

FIG. 2 is an example of a possible target profile. The preferred embodiment is one or more relational databases that contain all target profile data in a structured form. This will allow consumer information brokers 130 to quickly derive all relevant target profile data for each advertisement opportunity. The target profile factors or parameters can consist of, but is not limited to demographic data, product data, viewing habits, medical records, credit record, mortgage records, network usage habits (e.g. mobile phone usage: # SMS, # ring tone downloads, # Multi Media Messaging Service (MMS)), caller habits, etc. The example shows a relational database with four tables: Personal Data, Product Group Data, Product Data and Viewing Habit Data. The representation is a simplification of what a realistic relational database may look like and serves solely to provide more clarity. The structure and generation of relational databases is well understood by those skilled in the art. The example will be used in order to further explore the implementation of the preferred embodiment.

The following example serves to provide further clarity to the preferred embodiment of the invention. However, the invention is not intended to be limited to the specific example so selected, and it is to be understood that each element of this example includes all technical equivalents, which operate in a similar manner to accomplish a similar purpose.

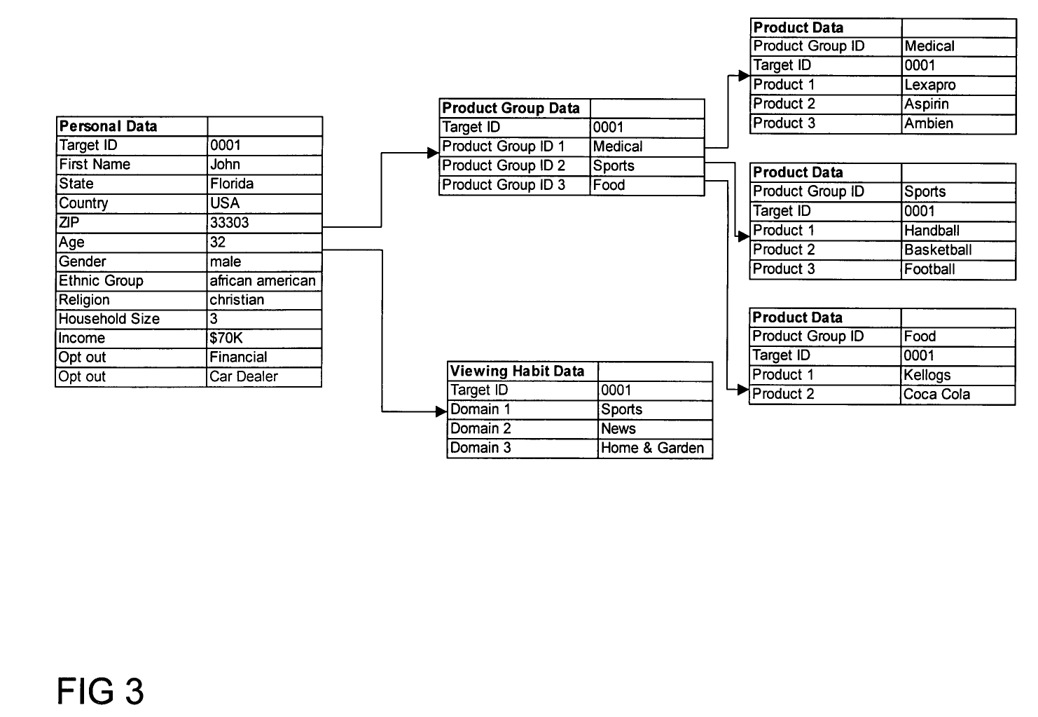

In order to improve the understanding of the invention a fictitious person “John” has been created to demonstrate the entire method of consumer data brokerage. FIG. 3 is a representation of John's target profile. When John accesses an advertisement platform on a communication network, a trigger or indication of availability is sent to the brokerage processor 138 [FIG. 1]. The brokerage processor 138 [FIG. 1] sends a trigger to the target profile database 131 and pulls John's target profile [FIG. 3]. In this example, the data contained in the target profile consists of Personal Data, Product Group Data, Product Data and Viewing Habit Data.

In the next step, the brokerage processor 138 checks if John allows his target profile to be utilized by all bidding advertisers 110 and then correlates John's target profile to the associated descriptions of the cleared advertisers 110. The brokerage processor 138 will only consider those advertisers 110 that have not been restricted in the target profile for the bidding process.

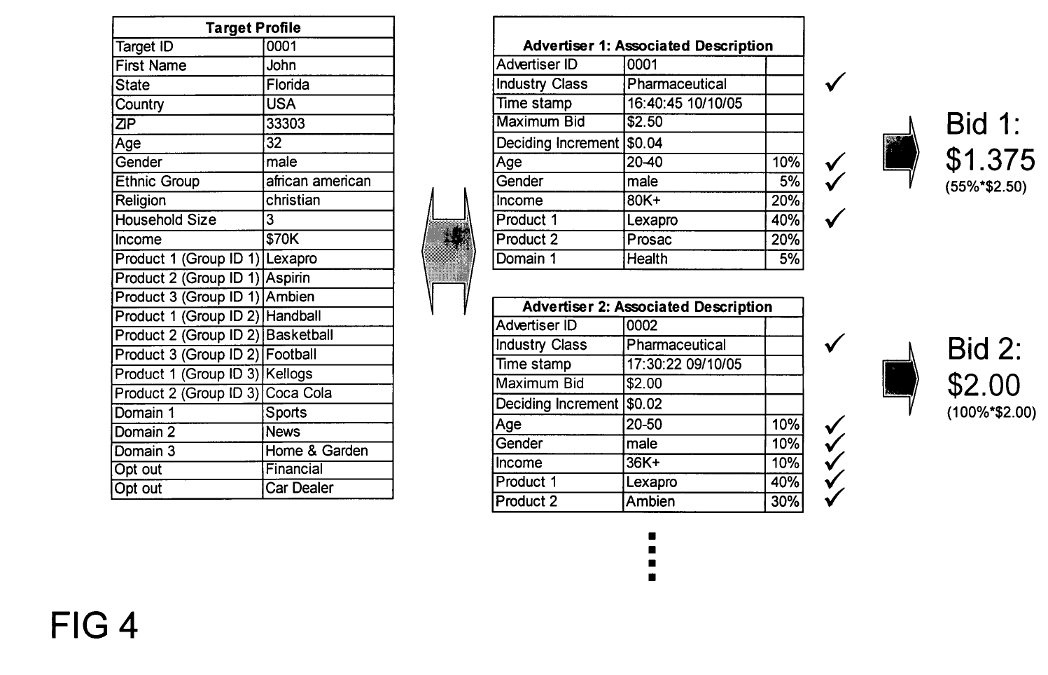

FIG. 4 is an example of two associated descriptions for Advertiser 1 and Advertiser 2. Each of the associated descriptions contains factors or parameters for an ideal target for that particular advertiser 110. Additionally the associated description will contain a bid price and a bid increment. All factors or parameters will contain absolute values or ranges that need to be matched in order for the factor or parameter to be considered met. In this example, Advertiser 1 has specified an Age parameter with a range of 20 to 40 years. John meets this parameter because he is 32 years old, as indicated in his target profile (FIG. 3). Additionally each factor or parameter of the associated description has a weight associated with it. The total of all weights in each associated description must equal 100%. In the example, the weight of the Age parameter for Advertiser 1 is 10%.

In the bidding process, the associated descriptions of all advertisers 110 get correlated to the target's target profile. The method calculates the sum of all weights associated with the parameters that are met. The resulting sum is multiplied by the advertiser's bid price in order to determine the dynamic bid price.

In the example, the associated description of Advertiser 1 contains matches for Age, Gender, Income and Product 1 and the associated description for Advertiser 2 contains matches for Age, Gender, Income, Product 1 and Product 2. The resulting dynamic bid for Advertiser 1 is $1.375=((10%+5%+40%)*$2.50) while the resulting dynamic bid for Advertiser 2 is $2.00=((10%+10%+10%+40%+30%)*$2.00). In this example, Advertiser 2 has the highest bid price, which is known as the winning bid. The winning bid must be equal to or higher than the minimum bid established by the target 190, advertisement platform provider 120 or consumer information broker 130. If the winning bid is less than the minimum bid, the winning bid will be adjusted to the minimum bid and the advertiser 110 will be charged the minimum bid price.

If two or more advertisers 110 have the same winning bid price, the brokerage processor 138 will add the bid increment of each advertiser 110 to their winning bid and determine the highest bid price again. If two advertisers 110 have the same winning bid, but one has a higher bid increment, the advertiser 110 with the higher bid increment becomes the winning advertiser 110. In FIG. 4, the bid increment of Advertiser 1 is 0.04$ and of Advertiser 2 is 0.02$. Therefore, if Advertiser 1 and 2 had the same highest bid price, the brokerage processor 138 automatically adds the bid increment to the highest bid price. In this scenario, Advertiser 1 would have the winning bid because Advertiser 1 has a higher bid increment than Advertiser 2.

As advertisers 110 register prior to the advertising opportunity, the brokerage processor 138 stores the time at which the advertiser 110 registered. If there are still two or more advertisers 110 with the same winning bid price and the same bid increment, the first advertiser 110 who registered for the bidding process of the advertisement opportunity becomes the winning advertiser 110. In FIG. 4, the time stamp of Advertiser 1 is 16:40:45 on 10/10/2005 and of Advertiser 2 is 17:30:22 on 9/10/2005. Therefore, if Advertiser 1 and 2 had the same dynamic bid price and bid increment, Advertiser 2 would become the winning advertiser because it registered before Advertiser 1.

Once the brokerage processor 138 has determined the winning advertiser, the brokerage processor 138 determines the best advertisement for that particular target 190. It utilizes the reference to marketing materials and their corresponding advertisement characterizations that the advertiser 110 has submitted to the consumer information broker 130 prior to the bidding process.

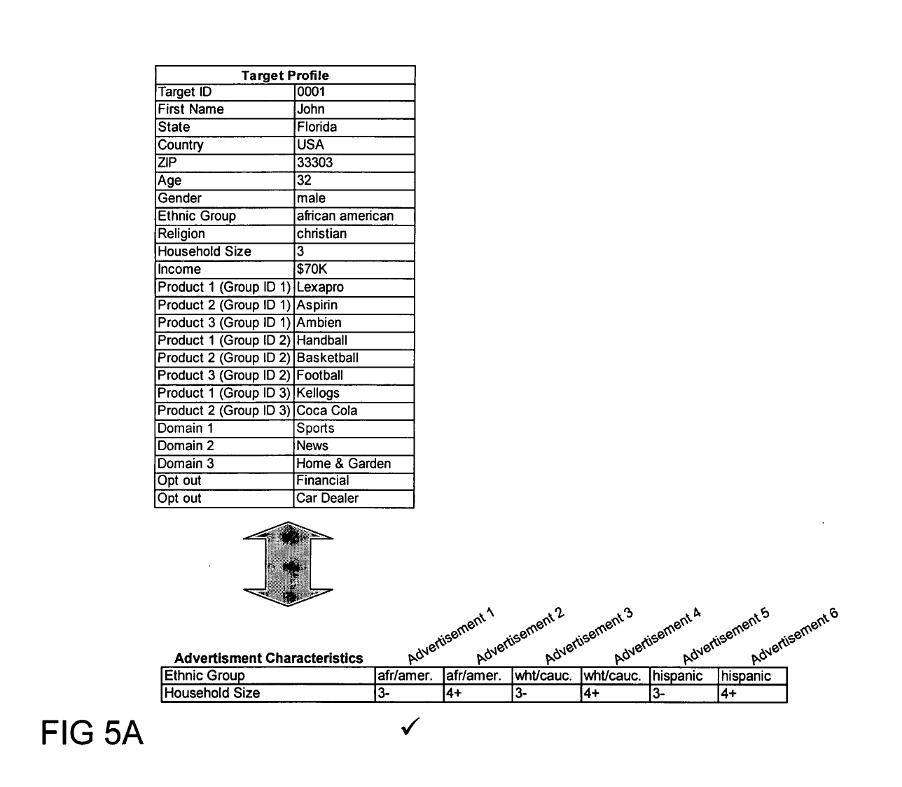

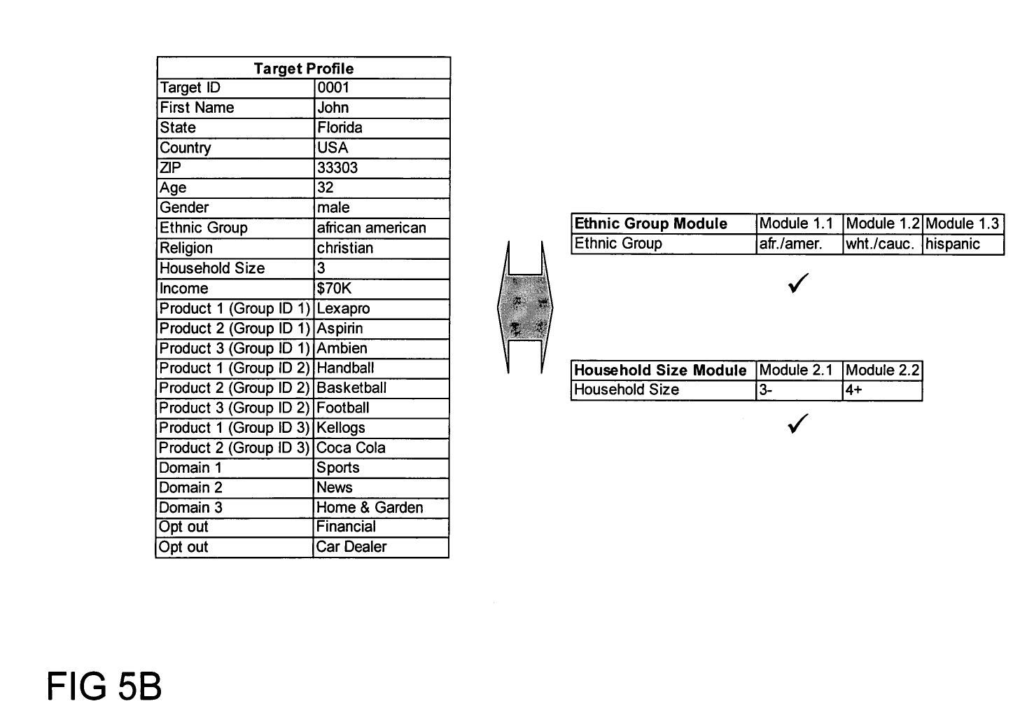

FIG. 5a is an example of the correlation of a specific advertisement opportunity with a target 190. While the general target market for a specific product might be huge, advertisers 110 would like to personalize their advertisement to the specific target 190 or group of targets 190 that they are addressing. This will increase the chance of successfully engaging the target 190. The present invention therefore offers the ability to customize advertisements based on the profile of a specific target 190. For this purpose the target profile is correlated to each advertisement characterization of the winning advertiser 110. The advertisement whose advertisement characterization best matches the target profile is selected and delivered to the target 190.

In the example, Advertiser 2 has won the opportunity to display an advertisement to John. Advertiser 2 has a set of different advertisements that include advertisement characterizations targeted to different ethnic groups and different sizes of households. Based on John's profile in FIG. 3 in which John is identified as African-American and living in a household with three people, the brokerage processor 138 automatically selects Advertisement 1 and delivers it to John.

An alternate implementation of the correlation of a specific advertisement with a target 190 is shown in FIG. 5b. The target profile is correlated to advertisement characterizations of advertisement modules, which can be combined to form one advertisement. The advertisement modules having advertisement characterizations that best fit the target profile are selected, combined and delivered to the target 190. In this example, the advertisement is composed of two modules: an ethnic group module and a household size module. Depending on the target profile, the brokerage processor 138 selects the relevant modules and combines them into one advertisement. In the example, the brokerage processor 138 selects Module 1.1 and Module 2.1 because John is an African-American consumer with a household size of three persons.

After the brokerage processor 138 has determined the best advertisement, it delivers the advertisement to the target 190 or requests the advertisement processor 132 to forward the advertisement to the target 190. The advertisement may be interactive, permitting feedback about the advertisement to be provided by the target 190 through the use of icons in browsers and on mail programs; icons on advertisement or links on advertisements; key strokes on telephones, cellular phones or pager; key strokes on remote controls for satellite or cable TV set top boxes; or any other feedback mechanism that targets 190 may use in order to confirm that they have viewed an advertisement presented to them.

Direct to Consumer Marketing Brokerage

For direct-to-consumer marketing materials, marketers 115 can use the consumer information broker 130 to identify targets 190 who correlate to the associated description requirements of the marketer 115 and relay marketing materials to them. Direct-to-consumer marketing materials include, but are not limited to promotional materials, static advertisements, surveys, questionnaires, telemarketing calls, direct mails, direct sales initiatives, catalogs, circulars, political commentary, sales announcements, want ads and any other material suitable for distribution in delayed-time.

Similarly to the advertisement brokerage, the direct-to-consumer marketing brokerage correlates the associated description of the marketer 115 to the target profiles of the targets 190. The marketer 115 may request the consumer information broker 130 to search for a specific number of targets 190 or to only provide the marketing materials to targets 190 that include specific factors or parameters.

Marketers 115 may pay each target 190 a fixed amount for the service. The consumer information broker 130, the advertisement platform provider 120 and/or the target 190 will determine the price.

The consumer information broker 130 delivers the marketing materials to the targets 190. This may happen without disclosing the targets' identities to the marketers 115. This can be done either by SMS, telephone, pager, e-mail or postal mail or any other suitable direct-to-consumer communication mean. In a preferred embodiment, consumer information broker 130 uses relay (forwarding) services or in the case of postal mail, address labeling services.

The account of the marketer 115 may be charged. The accounts of targets 190 and/or profilers 100 and/or platform providers may be credited. Consumer information brokers 130 may charge a percentage of the fee or a fixed sum for their services.

In FIG. 1 a consumer information broker 130 brokers the marketing process between target 190, profiler 100 and marketer 115. The consumer information broker 130 manages the process of finding the most suitable targets 190 for the marketing materials provided by the marketer 115 based on the marketer's associated description. The consumer information broker 130 may de-identify target 190 data, determine and/or convey the price for the marketer 115, relay the marketing materials to the target 190, charge the marketer's 115 account and credit the accounts of the target 190, the profiler 100 and/or the platform provider.

Marketers 115 have the opportunity to contract the consumer information broker 130 to relay specific marketing materials to targets 190. For that purpose they send an associated description, the maximum number of targets for the marketing campaign or the minimum required parameters that a target must have to receive the marketing materials, the chosen marketing platform (e.g. e-mail, postal mail, telephone, SMS, MMS, etc.) and a reference to the marketing materials to the consumer information broker 130. The associated description is a reflection of the ideal target 190 targeted for that particular marketing campaign. The associated description for each marketing activity will be stored on the brokerage processor 138 together with the maximum number of targets 190 or the minimum required parameters that a target 190 must have to receive the marketing materials, the chosen marketing platform (e.g. e-mail, postal mail, telephone, SMS, etc.) and a reference to the marketing materials.

Marketers 115 can use, but are not limited to, the following means in order to interact with targets 190: mobile telephones 170 or pagers 169 connected to a Mobile Switching Network 152; telephones 170 connected to the Public Switched Telephone Network (“PSTN”) 154; PC's 172 connected to the Internet 142 via the PSTN 154, a satellite network 158 or a cable network 156; set top boxes connected to cable networks 156 or satellite networks 158; TV sets 176 connected to cable networks 156, satellite networks 158 or the PSTN 154; Laptops or PDA's 178 connected to a WiFi network. Additionally, targets 190 can be reached by marketers 115 through print material of a printer server 164 in form of direct mail 182 or surveys on receipts 168 at the point of sale 150.

Based on the associated description, the number of targets 190 specified by the marketer 115 or the minimum required parameters that a target must have to receive the marketing materials, and the industry and name of the marketer 115 who requests the service, the brokerage processor 138 requests target profiles that match the associated description by accessing one or more target profile processors 131. The mechanism will be queries in one or more databases. The result will be a list of all targets 190 who match the associated description and whose target profiles state that they did not opt out of that particular industry or company.

The brokerage processor 138 relays the selected marketing materials to the selected targets by triggering the marketing processor 137 to forward the material.

The target profile is a data representation of a target 190. The information is collected through (1) the active data input of targets 190 into databases of target profile processors 131, (2) the tracking of the usage behavior of targets 190 collected in one or more databases of target profile processors 131, (3) the tracking of usage behavior of targets 190 stored in digital memory (e.g. smart cards, SIM cards, computer memory, etc.) or cookies residing on the target's premise equipment, and (4) the active data input of third parties concerning targets 190 into databases of target profile processors 131. Relevant data can be collected from, but is not limited to points of sale 150 or online sales using payment system records; from online appointment scheduling using customer information databases; from cookies tracking Internet viewing behavior; from Internet search engines tracking subjects of interest; from cable or satellite TV provider records tracking TV viewing behavior; from mobile or fixed telephone providers tracking service usage; and from consumer surveys or from any public records. The quality of the target profiles depends largely on the amount and accuracy of the information available. Targets 190 can have the opportunity to offer information to profilers 100 at a price, which could be reflected in discounts, bonus and reward programs, cash or any other legal incentive.

In both scenarios “advertisement brokerage” and “direct-to-consumer marketing brokerage”, the compensation of targets 190 can be in form of cash, contributions to checking accounts, college saving accounts, health saving accounts, IRA's, charity accounts, discounts, vouchers, new or existing loyalty programs, free fixed or wireless telephone minutes, free Internet usage, free cable or satellite usage, free pager of SMS, MMS messages, free downloads or any other form of legal incentives. The consumer information brokers 130 may perform the account maintenance.

I claim:

1. A method for providing marketing materials to targets in real-time, the method comprising:
determining that a target is available to receive one or more marketing materials;
determining a target profile for the target;
searching a database of bid entries based on the target profile for the target, each entry of the bid database including a reference to marketing materials, an associated description, a bid price, and a bid increment;
selecting at least one entry from the bid database to produce at least one preliminarily selected entry, wherein the at least one preliminarily selected entry includes an associated description that correlates with the target profile for the target;
in the event that the at least one preliminarily selected entry includes a first group of multiple entries from the bid database, selecting at least one entry from the first group to produce at least one intermediately selected entry, wherein the at least one intermediately selected entry includes a highest bid price;
in the event that the at least one intermediately selected entry includes a second group of multiple entries from the bid database, selecting at least one entry from the second group to produce at least one finally selected entry, wherein the at least one finally selected entry includes a highest bid increment; and
conveying marketing materials from the at least one finally selected entry to the target.

2. The method of claim 1, wherein the step of determining that a target is available comprises automatically receiving an indication of availability from an electronic link operated by the target.

3. The method of claim 1, wherein each entry of the bid database further includes a storage time associated with storage of the entry in the bid database, the method further comprising:
in the event that the at least one finally selected entry includes a third group of multiple entries from the bid database, selecting one entry from the third group wherein the selected third group entry includes a storage time that is earlier in time than storage times of remaining entries in the third group; and
wherein the step of conveying marketing materials to the target includes conveying marketing materials from the selected third group entry to the target.

4. The method of claim 1, wherein the step of conveying marketing materials to the target further comprises selecting marketing materials that most closely correlate to the target profile for the target.

5. The method of claim 1, further comprising receiving compensation from a marketer associated with the at least one finally selected entry.

6. The method of claim 1, wherein the step of conveying marketing materials includes conveying marketing materials via an advertisement platform, the method further comprising compensating a provider of the advertisement platform.

7. The method of claim 1, further comprising receiving feedback from the target.

8. The method of claim 7, further comprising compensating the target for providing the feedback.

9. The method of claim 7, further comprising forwarding the feedback received from the target to the marketer associated with the at least one finally selected entry.

10. The method of claim 1, wherein each associated description includes at least one target parameter, wherein the target profile includes at least one characteristic, and wherein the step of selecting at least one bid entry from the bid database comprises:
comparing the at least one target parameter of each associated description to the at least one characteristic; and
selecting each bid entry in which the at least one target parameter correlates with the at least one characteristic.

11. The method of claim 10, wherein the at least one target parameter includes a characteristic range and wherein the step of selecting each bid entry in which the at least one target parameter correlates with the at least one characteristic comprises:
selecting each bid entry in which the characteristic range includes the at least one characteristic.

12. A system for providing marketing materials to targets in real-time, the system comprising:
a network interface operable to exchange data with a communication network;
at least one processor operably coupled to the network interface and including a target profile database and a bid database;
the target profile database operably coupled to the at least one processor, each entry of the target profile database including a target profile;
a bid database operably coupled to the at least one processor, each entry of the bid database including a reference to marketing materials, an associated description, a bid price, and a bid increment;
memory coupled to the at least one processor having stored therein a software program that, when executed by the at least one processor, directs the at least one processor to perform the following functions:
determine that a target is available to receive one or more marketing materials;
search the target profile database to determine a target profile for the target;
search the bid database based on the target profile for the target;
select at least one entry from the bid database to produce at least one preliminarily selected entry, wherein the at least one preliminarily selected entry includes an associated description that correlates with the target profile for the target;
in the event that the at least one preliminarily selected entry includes a first group of multiple entries from the bid database, select at least one entry from the first group to produce at least one intermediately selected entry, wherein the at least one intermediately selected entry includes a highest bid price;
in the event that the at least one intermediately selected entry includes a second group of multiple entries from the bid database, select at least one entry from the second group to produce at least one finally selected entry, wherein the at least one finally selected entry includes a highest bid increment; and
convey marketing materials from the at least one finally selected entry to the target via the network interface.

13. The system of claim 12, wherein the at least one processor comprises a server.

14. The system of claim 12, wherein at least one of the target profile database and the bid database are operably coupled to the at least one processor via the network interface.

15. The system of claim 12, wherein the at least one processor determines that a target is available by automatically receiving an indication of availability from an electronic link operated by the target.

16. The system of claim 12, wherein each entry of the bid database further includes a storage time associated with storage of the entry in the bid database and wherein the software program, when executed by the at least one processor, causes the at least one processor to perform the following additional function:
in the event that the at least one finally selected entry includes a third group of multiple entries from the bid database, select one entry from the third group wherein the selected third group entry includes a storage time that is earlier in time than storage times of remaining entries in the third group; and
wherein the at least one processor conveys marketing materials to the target by conveying marketing materials from the selected third group entry to the target.

17. The system of claim 12, wherein the at least one processor conveys marketing materials to the target by selecting marketing materials that most closely correlate to the target profile for the target.

18. The system of claim 12, wherein the software program, when executed by the at least one processor, causes the at least one processor to perform the following additional function:
receive compensation from a marketer associated with the at least one finally selected entry.

19. The system of claim 12, wherein the at least one processor conveys marketing materials by conveying marketing materials via an advertisement platform, and
wherein the software program, when executed by the at least one processor, additionally causes the at least one processor to compensate a provider of the advertisement platform.

20. The system of claim 12, wherein the software program, when executed by the at least one processor, causes the at least one processor to perform the following additional function: receive feedback from the target.

21. The system of claim 20, wherein the software program, when executed by the at least one processor, causes the at least one processor to perform the following additional function: compensate the target for providing the feedback.

22. The system of claim 20, wherein the software program, when executed by the at least one processor, causes the at least one processor to perform the following additional function: forward the feedback received from the target to the marketer associated with the at least one finally selected entry.

23. The system of claim 12, wherein each associated description includes at least one target parameter, wherein the target profile includes at least one characteristic, and wherein the function of selecting at least one bid entry from the bid database comprises:
comparing the at least one target parameter of each associated description to the at least one characteristic; and
selecting each bid entry in which the at least one target parameter correlates with the at least one characteristic.

24. The system of claim 23, wherein the at least one target parameter includes a characteristic range and wherein the function of selecting each bid entry in which the at least one target parameter correlates with the at least one characteristic comprises:
selecting each bid entry in which the characteristic range includes the at least one characteristic.

25. A computer readable medium having stored thereon a software program that, when executed by at least one processor, causes the at least one processor to perform the following functions:
determine that a target is available to receive one or more marketing materials;
determine a target profile for the target;
search a database of bid entries based on the target profile for the target, each entry of the bid database including a reference to marketing materials, an associated description, a bid price, and a bid increment;
select at least one entry from the bid database to produce at least one preliminarily selected entry, wherein the at least one preliminarily selected entry includes an associated description that correlates with the target profile for the target;
in the event that the at least one preliminarily selected entry includes a first group of multiple entries from the bid database, select at least one entry from the first group to produce at least one intermediately selected entry, wherein the at least one intermediately selected entry includes a highest bid price;
in the event that the at least one intermediately selected entry includes a second group of multiple entries from the bid database, select at least one entry from the second group to produce at least one finally selected entry, wherein the at least one finally selected entry includes a highest bid increment; and
convey marketing materials from the at least one finally selected entry to the target.

26. The computer readable medium of claim 25, wherein the at least one processor determines that a target is available by automatically receiving an indication of availability from an electronic link operated by the target.

27. The computer readable medium of claim 25, wherein each entry of the bid database further includes a storage time associated with storage of the entry in the bid database and wherein the software program, when executed by the at least one processor, causes the at least one processor to perform the following additional function:
in the event that the at least one finally selected entry includes a third group of multiple entries from the bid database, select one entry from the third group wherein the selected third group entry includes a storage time that is earlier in time than storage times of remaining entries in the third group; and
wherein the at least one processor conveys marketing materials to the target by conveying marketing materials from the selected third group entry to the target.

28. The computer readable medium of claim 25, wherein the at least one processor conveys marketing materials to the target by selecting marketing materials that most closely correlate to the target profile for the target.

29. The computer readable medium of claim 25, wherein the software program, when executed by the at least one processor, causes the at least one processor to perform the following additional function:
receive compensation from a marketer associated with the at least one finally selected entry.

30. The computer readable medium of claim 25, wherein the at least one processor conveys marketing materials by conveying marketing materials via an advertisement platform, and
wherein the software program, when executed by the at least one processor, additionally causes the at least one processor to compensate a provider of the advertisement platform.

31. The computer readable medium of claim 25, wherein the software program, when executed by the at least one processor, causes the at least one processor to perform the following additional function: receive feedback from the target.

32. The computer readable medium of claim 31, wherein the software program, when executed by the at least one processor, causes the at least one processor to perform the following additional function: compensate the target for providing the feedback.

33. The computer readable medium of claim 31, wherein the software program, when executed by the at least one processor, causes the at least one processor to perform the following additional function: forward the feedback received from the target to the marketer associated with the at least one finally selected entry.

34. The computer readable medium of claim 25, wherein each associated description includes at least one target parameter, wherein the target profile includes at least one characteristic, and wherein the function of selecting at least one bid entry from the bid database comprises:
comparing the at least one target parameter of each associated description to the at least one characteristic; and
selecting each bid entry in which the at least one target parameter correlates with the at least one characteristic.

35. The computer readable medium of claim 34, wherein the at least one target parameter includes a characteristic range and wherein the function of selecting each bid entry in which the at least one target parameter correlates with the at least one characteristic comprises:
selecting each bid entry in which the characteristic range includes the at least one characteristic.

36. A method for providing marketing materials to one or more targets, the method comprising:
receiving a reference to marketing materials and an associated description from a marketer;
searching a target profile database based on the associated description, each entry of the database including a target profile;
selecting at least one entry from the target profile database to produce at least one selected entry, wherein the at least one selected entry includes a target profile that correlates with the associated description;
conveying marketing materials from the marketer to the at least one selected entry.

37. The method of claim 36, wherein the step of conveying marketing materials to the at least one selected entry further comprises selecting marketing materials that most closely correlates to the target profile for each selected target.

38. The method of claim 36, further comprising receiving compensation from the marketer.

39. The method of claim 36, wherein the step of conveying marketing materials includes conveying marketing materials via an advertisement platform, the method further comprising compensating a provider of the advertisement platform.

40. The method of claim 36, further comprising receiving feedback from at least one selected entry.

41. The method of claim 40, further comprising compensating the at least one selected entry for providing the feedback.

42. The method of claim 40, further comprising forwarding the feedback received from the at least one selected entry to the marketer.

43. The method of claim 36, wherein each target profile includes at least one characteristic, wherein the associated description includes at least one target parameter, and wherein the step of selecting at least one target profile entry from the target profile database comprises:
comparing the at least one characteristic of each target profile entry to the at least one target parameter; and
selecting each target profile entry in which the at least one characteristic correlates with the at least one target parameter.

44. The method of claim 43, wherein the at least one target parameter includes a characteristic range and wherein the step of selecting each target profile entry in which the at least one characteristic correlates with the at least one target parameter comprises:
selecting each target profile entry in which the at least one characteristic is included in the characteristic range.

45. A system for providing marketing materials to one or more targets, the system comprising:
a network interface operable to exchange data with a communication network;
at least one processor operably coupled to the network interface and including a target profile database;
the target profile database operably coupled to the at least one processor, each entry of the target profile database including a target profile;
memory coupled to the at least one processor having stored therein a software program that, when executed by the at least one processor, directs the at least one processor to perform the following functions:
receive a reference to marketing materials and an associated description from a marketer;
search the target profile database based on the associated description;
select at least one entry from the target profile database to produce at least one selected entry, wherein the at least one selected entry includes a target profile that correlates with the associated description;
convey marketing materials from the marketer to the at least one selected entry.

46. The system of claim 45, wherein the at least one processor comprises a server.

47. The system of claim 45, wherein the target profile database is operably coupled to the at least one processor via the network interface.

48. The system of claim 45, wherein the at least one processor conveys marketing materials to the at least one selected entry by selecting marketing materials that most closely correlate to the target profile for each selected target.

49. The system of claim 45, wherein the software program, when executed by the at least one processor, causes the at least one processor to perform the following additional function:
receive compensation from the marketer.

50. The system of claim 45, wherein the at least one processor conveys marketing materials by conveying marketing materials via an advertisement platform, and
wherein the software program, when executed by the at least one processor, additionally causes the at least one processor to compensate a provider of the advertisement platform.

51. The system of claim 45, wherein the software program, when executed by the at least one processor, causes the at least one processor to perform the following additional function: receive feedback from the at least one selected entry.

52. The system of claim 51, wherein the software program, when executed by the at least one processor, causes the at least one processor to perform the following additional function: compensate the at least one selected entry for providing the feedback.

53. The system of claim 51, wherein the software program, when executed by the at least one processor, causes the at least one processor to perform the following additional function: forward the feedback received from the at least one selected entry to the marketer.

54. The system of claim 45, wherein each target profile includes at least one characteristic, wherein the associated description includes at least one target parameter, and wherein the function of selecting at least one target profile entry from the target profile database comprises:
comparing the at least one characteristic of each target profile to the at least one target parameter; and
selecting each target profile entry in which the at least one characteristic correlates with the at least one target parameter.

55. The system of claim 54, wherein the at least one target parameter includes a characteristic range and wherein the function of selecting each target profile entry in which the at least one characteristic correlates with the at least one target parameter comprises:
selecting each target profile entry in which the at least one characteristic is included in the characteristic range.

56. A computer readable medium having stored thereon a software program that, when executed by at least one processor, causes the at least one processor to perform the following functions:
receive a reference to marketing materials and an associated description from a marketer;
search a target profile database based on the associated description, each entry of the target profile database including a target profile;
select at least one entry from the target profile database to produce at least one selected entry, wherein the at least one selected entry includes a target profile that correlates with the associated description;
convey marketing materials from the marketer to the at least one selected entry.

57. The computer readable medium of claim 56, wherein the at least one processor conveys marketing materials to the at least one selected entry by selecting marketing materials that most closely correlates to the target profile for each selected target.

58. The computer readable medium of claim 56, wherein the software program, when executed by the at least one processor, causes the at least one processor to perform the following additional function:
receive compensation from the marketer.

59. The computer readable medium of claim 56, wherein the at least one processor conveys marketing materials by conveying marketing materials via an advertisement platform, and
wherein the software program, when executed by the at least one processor, additionally causes the at least one processor to compensate a provider of the advertisement platform.

60. The computer readable medium of claim 56, wherein the software program, when executed by the at least one processor, causes the at least one processor to perform the following additional function: receive feedback from the at least one selected entry.

61. The computer readable medium of claim 60, wherein the software program, when executed by the at least one processor, causes the at least one processor to perform the following additional function: compensate the at least one selected entry for providing the feedback.

62. The computer readable medium of claim 60, wherein the software program, when executed by the at least one processor, causes the at least one processor to perform the following additional function: forward the feedback received from the at least one selected entry to the marketer.

63. The computer readable medium of claim 56, wherein each target profile includes at least one characteristic, wherein the associated description includes at least one target parameter, and wherein the function of selecting at least one target profile entry from the target profile database comprises:
comparing the at least one characteristic of each target profile to the at least one target parameter; and
selecting each target profile entry in which the at least one characteristic correlates with the at least one target parameter.

64. The computer readable medium of claim 63, wherein the at least one target parameter includes a characteristic range and wherein the step of selecting each target profile entry in which the at least one characteristic correlates with the at least one target parameter comprises:
selecting each target profile entry in which the at least one characteristic is included in the characteristic range.
